(19) United States
(12) Patent Application Publication
(10) Pub. No.: US 2011/0251885 A1
(43) Pub. Date: Oct. 13, 2011

(54) Differentiated experience for user generated content (UGC) based on popularity

(75) Inventor: Shawn Abigail, Kanata (CA)

(73) Assignee: Alcatel-Lucent Canada

(21) Appl. No.: 12/798,716

(22) Filed: Apr. 9, 2010

(51) Int. Cl. G06Q 30/00; G06Q 50/00; G06F 15/16

(52) U.S. Cl. 705/14.31; 709/224; 705/14.39

(57) ABSTRACT

The preferred method involves receiving user generated content from an end user terminal at a web server; inserting an advertisement into the beginning of the user generated content; monitoring each occasion on which the user generated content is accessed from the web server; adjusting the length of the advertisement after the user generated content is accessed a threshold number of times; adjusting the quality of the user generated content after the user generated content is accessed a threshold number of times; and increasing the number of distribution channels for the user generated content after the user generated content is accessed a threshold number of times.

### CROSS REFERENCE TO RELATED APPLICATIONS

This United States non-provisional patent application does not claim priority to any United States provisional patent application or any foreign patent application.

### FIELD OF THE DISCLOSURE

The disclosures made herein relate generally to the telecommunications industry. The invention discussed herein is in the general classification of a device, system and method for providing a differentiated user experience for user generated content (UGC) based on popularity of the user generated content.

### BACKGROUND

This section introduces aspects that may be helpful in facilitating a better understanding of the invention. Accordingly, the statements of this section are to be read in this light and are not to be understood as admissions about what is in the prior art or what is not in the prior art.

Several technical terms or phrases will be used throughout this application and merit a brief explanation.

User generated content (UGC) refers to media content created by end users. UGC may include a variety of digital media technologies, including, but not limited to, video, podcasting and blogging.

YouTube is one example of a website with a large amount of user generated content, including music and entertainment videos created by end users and uploaded to the YouTube website to be shared with other end users. YouTube is currently the most popular video distribution service. Others, including Google video, Yahoo video and America Online (AOL) uncut video, are becoming increasingly popular.

A content delivery network or content distribution network (CDN) refers to a system of computers that all contain copies of data and are placed throughout a network rather than simply having all data stored in a central server. This arrangement of computers permits the network to maximize bandwidth for access to the data from clients spread throughout the network, including clients that would be located remotely from the central server.

User generated content traditionally is presented in the same manner regardless of its popularity. While content delivery networks allow efficient transmittal of the content, the user experience is identical for all end users. For example, if an end user uploads a video that he created to one of the video distribution services (e.g. YouTube), all end users will have the same end user experience after downloading and watching the video. If the video distribution service prepends an advertisement to the beginning of the end user submitted and uploaded video, all end users will view the advertisement for the same amount of time. All end users will also experience the video and the advertisement at the same quality level (e.g. standard definition or high definition). Every end user will have access to the video through the same distribution channels.

Currently, there is no acceptable, existing solution for providing a differentiated end user experience for user generated content based on popularity of the user generated content.

Hence, there is a need for a device, system and method that efficiently, reliably and affordably permit end users to have differentiated experiences based on the popularity of the user generated content being viewed.

### SUMMARY OF THE DISCLOSURE

The preferred system permits receiving user generated content at an entity's web server for access via the entity's website from an end user terminal. An end user ordinarily creates, displays and/or saves user generated content on his end user terminal. The end user then sends user generated content (e.g. a video) from his end user terminal to the web server of the entity (e.g. a video distribution network) of his choice to share with other end users of that entity via that entity's website address. The web server of the entity is capable of monitoring each occasion on which the user generated content is accessed from the web server of the entity and providing a reward to all end users when the user generated content is accessed a threshold number of times.

The preferred method involves: receiving user generated content from an end user terminal at a web server of an entity; inserting an advertisement into the beginning of the user generated content; monitoring each occasion on which the user generated content is accessed from the web server of the entity; and adjusting the length of the advertisement after the user generated content is accessed a threshold number of times.

The preferred method may further or alternatively involve: adjusting the quality (e.g. resolution of a video) of the user generated content after the user generated content is accessed a threshold number of times.

The preferred method may further or alternatively involve: increasing the number of and/or changing the type of distribution channels for the user generated content after the user generated content is accessed a threshold number of times.

The preferred device has a memory containing instructions. The instructions are processed by a processor. The instructions permit receiving user generated content sent from an end user terminal; inserting an advertisement into the beginning of the user generated content; monitoring each occasion on which the user generated content is accessed; and adjusting the length of the advertisement after the user generated content is accessed the threshold number of times. The instructions further permit adjusting the quality of the user generated content after the user generated content is accessed the threshold number of times. The instructions further permit increasing the number of and/or changing the type of distribution channels for the user generated content after the user generated content is accessed a threshold number of times.

Under some applications, embodiments may provide a system and method that are relatively inexpensive to implement that provide a differentiated end user experience for user generated content based on the popularity of the user generated content.

Under some applications, embodiments may provide a device, system and method that are not operationally complex that provide a differentiated end user experience for user generated content based on the popularity of the user generated content.

Under some applications, embodiments may provide a device, system and method that efficiently provide a differentiated end user experience for user generated content based on the popularity of the user generated content.

Under some applications, embodiments may provide a reliable device, system and method to provide a differentiated end user experience for user generated content based on the popularity of the user generated content.

Under some applications, embodiments may provide a device and system that are relatively inexpensive to manufacture and deploy that provide a differentiated end user experience for user generated content based on the popularity of the user generated content.

### BRIEF DESCRIPTION OF THE DRAWINGS

Some embodiments of apparatus and/or methods of the present invention are now described, by way of example only, and with reference to the accompanying drawings, in which:

FIG. 1 schematically illustrates a system for providing user generated content to and from a web server of an entity.

FIG. 2 depicts the method of the preferred embodiment for modifying advertisement length based on popularity of user generated content.

FIG. 3 depicts the method of the preferred embodiment for modifying user generated content quality based on popularity of user generated content.

FIG. 4 depicts the method of the preferred embodiment for increasing the number of distribution channels for user generated content based on the popularity of the user generated content.

FIG. 5 depicts the device of the preferred embodiment capable of providing a reward to end users based on popularity of user generated content.

### DETAILED DESCRIPTION OF THE DRAWINGS

It is contemplated that the method described herein can be implemented as software, including a computer-readable medium having program instructions executing on a computer, hardware, firmware, or a combination thereof. The method described herein also may be implemented in various combinations on hardware and/or software.

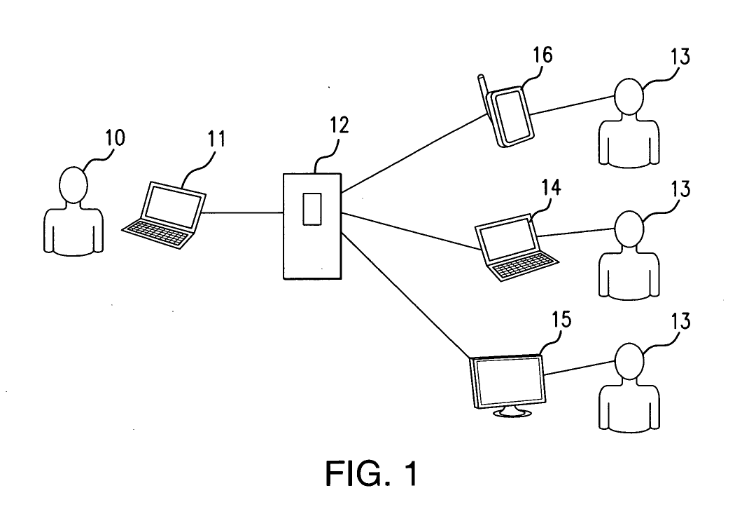

FIG. 1 schematically illustrates a system for providing user generated content to and from a web server of an entity. An end user 10 creates user generated content (e.g. a video) and/or saves and/or displays the user generated content on his end user terminal 11. The end user terminal could be a computer or other device, including a mobile device. The end user 10 then sends the video from his end user terminal 11 to the web server of the entity (e.g. video distribution network) 12 of his choice to share with other end users 13. The end users 13 access the user generated content from the web server of the entity 12 using their end user terminals 14, 15 and 16.

When an end user 10 first sends user generated content, it begins as unpopular content (i.e. other end users have not accessed it). At first, the user generated content may only be offered on a single channel available to, for example, the cellular phone 16. However, as the user generated content becomes more popular as users access it, the user generated content can then be offered on three different distribution channels, making it available to the cellular phone 16, the computer 14 and the television 15.

Typically, the web server of the entity 12 will prepend an advertisement to a video when it is submitted as user generated content to generate revenue for the entity/video distribution network. In the preferred embodiment, if a video becomes popular, the length of the advertisement prepended to the video is adjusted. For example, after the user generated content is accessed a threshold number of times (e.g. 100,000 times), the advertisement prepended to the front of the video could be adjusted from a thirty (30) second advertisement to a fifteen (15) second advertisement. The web server 12 could monitor each time a video is accessed by using a counter or other means and could compare the counter total to the threshold value.

Several different threshold values could be set to permit adjustments in advertisement length. For example, after the user generated content is accessed a second threshold number of times (e.g. 200,000 times), the advertisement length could be further adjusted to five (5) seconds. Obviously, adjusting the length of the advertisement may involve replacing the advertisement with a separate and potentially shorter advertisement or potentially reducing the length of the current advertisement.

Adjusting the advertisement length is a reward to the end users who access the video because they do not need to endure the entire advertisement (i.e. spend an additional thirty (30) seconds every time they view the video). Adjusting the advertisement length also can be a benefit to the video distribution network because it can obtain revenue from the advertisement each time the video is downloaded. Even if the video distribution network obtains less revenue from advertisers for shorter advertisements, the increased viewing of the videos due to increased demand from the shorter advertisements could enhance the revenue stream.

In the preferred embodiment, the more frequently a video is viewed, the more the video distribution network will enhance the video quality. For example, a video could be uploaded in high definition but only made available in lower resolution until it is accessed a threshold number of times. The video quality can be enhanced from standard definition to high definition after the video has been accessed a threshold number of times (e.g. 250,000 times). Multiple different thresholds could be chosen to permit enhanced video resolution and the threshold values chosen could align with or be different from the values chosen related to adjustment of advertisement length and the increase of distribution channels.

Because a video distribution network utilizing this differentiated experience for end users would build a larger community of end users, the increased number of end users would create the additional traffic for videos on that video distribution network.

Online communities could potentially develop to create a better online experience for all end users. User generated content developers will have more incentive to encourage other end users to download their content to permit all members of the community to receive additional benefits. A user could even have a channel dedicated to his user generated content. If the end user creates good and/or valuable content, more end users will potentially subscribe and the increased number of views/accesses to his user generated content will enhance the user experience for all members of that community.

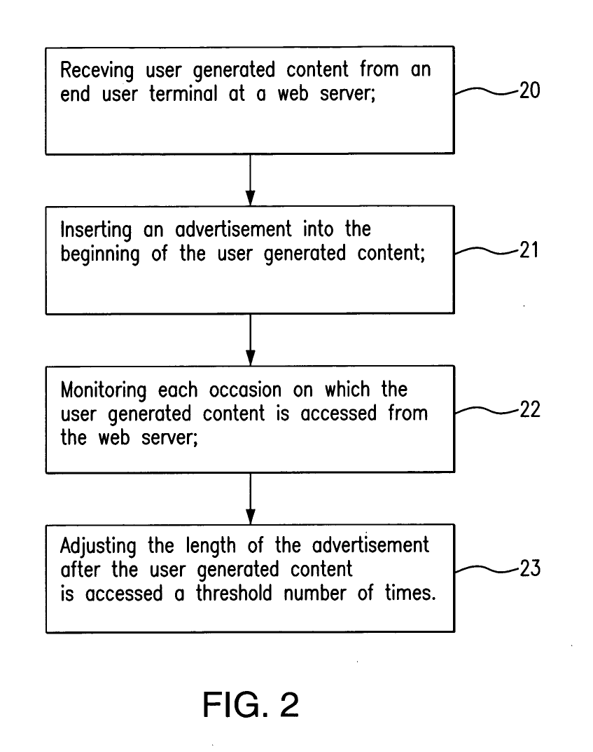

FIG. 2 depicts the method of the preferred embodiment for modifying advertisement length based on popularity of user generated content. An operation is performed for receiving user generated content from an end user terminal at a web server 20. An operation is performed for inserting an advertisement into the beginning of the user generated content 21. An operation is performed for monitoring each occasion on which the user generated content is accessed from the web server 22. An operation is performed for adjusting the length of the advertisement after the user generated content is accessed a threshold number of times 23.

Alternatively, several different threshold levels could be established such that the length of advertisement changes when each threshold level is reached. As previously discussed, changing the advertisement length may include changing the type of advertisement altogether.

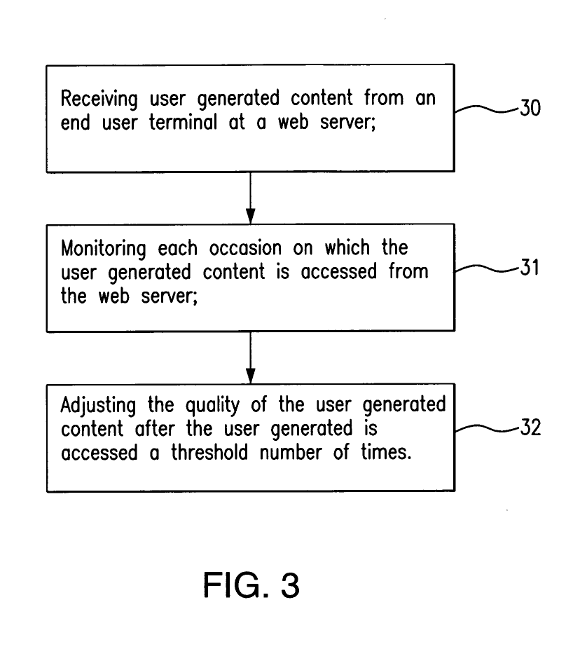

FIG. 3 depicts the method of the preferred embodiment for modifying user generated content quality based on popularity of user generated content. An operation is performed for receiving user generated content from an end user terminal at a web server 30. An operation is performed for monitoring each occasion on which the user generated content is accessed from the web server 31. An operation is performed for adjusting the quality of the user generated content after the user generated content is accessed a threshold number of times 32. In certain embodiments, the quality of the user generated content could switch (i.e. be adjusted) from standard definition to high definition for a video.

Alternatively, several different threshold levels could be established such that the quality of the user generated content changes when each threshold level is reached. In some embodiments, the switch in quality of the user generated content could occur at the same threshold value as a change in the length of an advertisement prepended to the user generated content.

Alternatively, some other award or reward could be issued based on the user generated content being accessed a threshold number of times. Any type of award or reward based on attaining the threshold value would create differentiation of the end user experience for more popular user generated content.

Rewards issued based on the number of times user generated content is accessed could take a wide variety of forms, depending on the type of user generated content. Changing font types, font sizes or quality of video, increasing the number of distribution channels and reducing or eliminating advertisements related to the user generated content are only some of the possible rewards. Rewards are usually in the form of a benefit, usually to the end users, involving a change in or related to the user generated content.

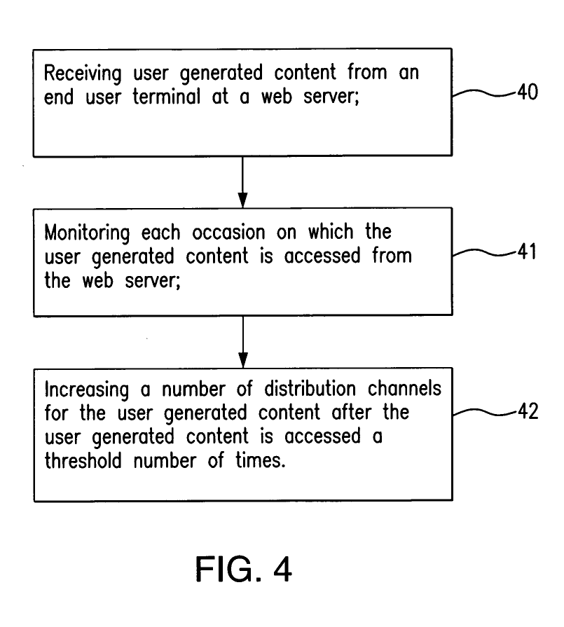

FIG. 4 depicts the method of the preferred embodiment for increasing the number of distribution channels for user generated content based on popularity of user generated content. An operation is performed for receiving user generated content from an end user terminal at a web server 40. An operation is performed for monitoring each occasion on which the user generated content is accessed from the web server 41. An operation is performed for increasing a number of distribution channels for the user generated content after the user generated content is accessed a threshold number of times 42. Alternatively, an operation could be performed for changing a type of distribution channel for the user generated content after the user generated content is accessed a threshold number of times. For example, the user generated content could change from only being available to cellular phone users to only being available to computer users.

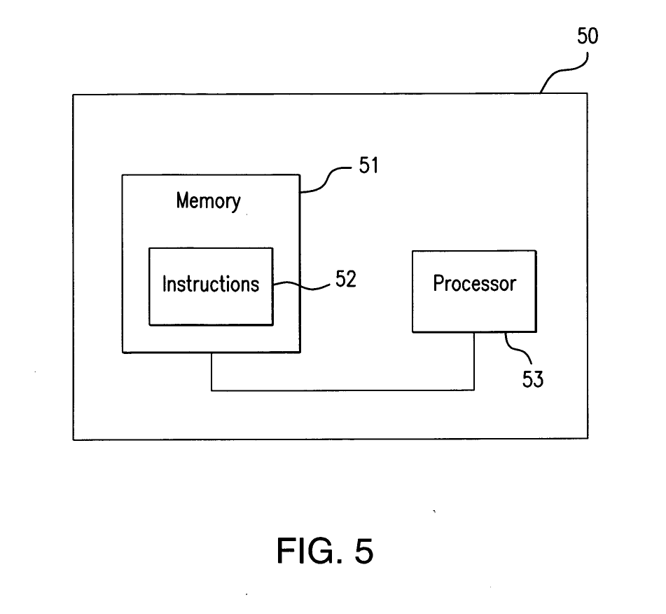

FIG. 5 depicts the device of the preferred embodiment capable of providing a reward to end user based on popularity of end user content. The device 50 contains a memory 51 containing instructions 52. The instructions 52 are processed by a processor 53. The instructions permit receiving user generated content sent from an end user terminal; inserting an advertisement at the beginning of the user generated content; monitoring each occasion on which the user generated content is accessed; and adjusting a length of the advertisement after the user generated content is accessed a threshold number of times. The instructions further permit adjusting a quality of the user generated content after the user generated content is accessed a threshold number of times. The instructions further permit increasing a number of distribution channels for the user generated content after the user generated content is accessed a threshold number of times. The instructions may further permit changing the type of distribution channel after the user generated content is accessed a threshold number of times. The instructions may further permit other rewards to be issued based on the popularity of the user generated content.

A person of skill in the art would readily recognize that steps of the various above-described methods can be performed by programmed computers and the order of the steps is not necessarily critical. Herein, some embodiments are intended to cover program storage devices, e.g., digital data storage media, which are machine or computer readable and encode machine-executable or computer executable programs of instructions where said instructions perform some or all of the steps of methods described herein. The program storage devices may be, e.g., digital memories, magnetic storage media such as magnetic disks or tapes, hard drives, or optically readable digital data storage media. The embodiments are also intended to cover computers programmed to perform said steps of methods described herein.

It will be recognized by those skilled in the art that changes or modifications may be made to the above-described embodiments without departing from the broad inventive concepts of the invention. It should therefore be understood that this invention is not limited to the particular embodiments described herein, but is of the invention as set forth in the claims.

What is claimed is:

1. A method for providing a differentiated experience related to user generated content comprising the steps of:
(a) receiving user generated content from an end user terminal at a web server;
(b) monitoring each occasion on which the user generated content is accessed from the web server; and
(c) providing a reward when the user generated content is accessed a threshold number of times.

2. The method of claim 1 wherein the user generated content is a video.

3. The method of claim 2 further comprising the step of:
inserting an advertisement into the beginning of the video and wherein providing the reward involves adjusting a length of the advertisement when the video is accessed the threshold number of times.

4. The method of claim 3 wherein adjusting the length of the advertisement involves shortening the length of the advertisement.

5. The method of claim 1 wherein the end user terminal is selected from the group consisting of a computer and a mobile device.

6. The method of claim 3 further comprising the step of:
providing a second reward when the video is accessed a second threshold number of times.

7. The method of claim 6 wherein providing the second reward involves again adjusting the length of the advertisement when the video is accessed the second threshold number of times.

8. The method of claim 2 wherein providing the reward involves adjusting a quality of the video when the video is accessed the threshold number of times.

9. The method of claim 8 wherein adjusting the quality of the video involves changing the quality of the video from standard definition to high definition.

10. The method of claim 1 wherein providing the reward involves increasing a number of distribution channels for the user generated content.

11. A device for providing a differentiated experience to end users related to user generated content comprising:
(a) a memory containing a set of instructions for receiving user generated content sent from an end user terminal; monitoring each occasion on which the user generated content is accessed; providing a reward when the user generated content is accessed a threshold number of times; and
(b) a processor for processing the set of instructions.

12. The device of claim 11 wherein the user generated content is a video and the set of instructions further include instructions for inserting an advertisement into the beginning of the video.

13. The device of claim 12 wherein the instructions for providing the reward when the video is accessed the threshold number of times include instructions for adjusting a length of the advertisement.

14. The device of claim 13 wherein the instructions for adjusting the length of the advertisement include instructions for shortening the length of the advertisement.

15. The device of claim 14 wherein the set of instructions further include instructions for providing a second reward when the video is accessed a second threshold number of times.

16. The device of claim 15 wherein the instructions for providing the second reward when the video is accessed the second threshold number of times include instructions for again adjusting the length of the advertisement.

17. The device of claim 16 wherein the instructions for again adjusting the length of the advertisement include instructions for shortening the length of the advertisement.

18. The device of claim 11 wherein the user generated content is a video and wherein the instructions for providing the reward when the video is accessed the threshold number of times include instructions for adjusting a quality of the video.

19. The device of claim 18 wherein the instructions for adjusting the quality of the video include instructions for changing the quality of the video from standard definition to high definition.

20. The device of claim 11 wherein the user generated content is a video and wherein the instructions for providing the reward when the video is accessed the threshold number of times include instructions for increasing a number of distribution channels for the video.
